(19) United States
(12) Patent Application Publication
(10) Pub. No.: US 2020/0089459 A1
(43) Pub. Date: Mar. 19, 2020

(54) DISPLAY CONTROL APPARATUS, DISPLAY APPARATUS, AND NON-TRANSITORY COMPUTER READABLE MEDIUM

(71) Applicant: FUJI XEROX CO., LTD., Tokyo (JP)

(72) Inventor: Xiaojing ZHANG, Kanagawa (JP)

(73) Assignee: FUJI XEROX CO., LTD., Tokyo (JP)

(21) Appl. No.: 16/565,454

(22) Filed: Sep. 9, 2019

(30) Foreign Application Priority Data
Sep. 19, 2018 (JP) 2018-175038

(51) Int. Cl. G06F 3/14; G06F 3/147; G06F 3/041; G06F 1/16

(52) U.S. Cl. CPC G06F 3/1423; G06F 3/147; G06F 1/1641; G06F 1/1652; G06F 3/0416

(57) ABSTRACT

A display control apparatus includes a controller. The controller controls a bendable display to display a first screen if the display is deformed in a state where a specific application program is in a first state. The controller controls the display to display a second screen, which is different from the first screen, if the display is deformed in a state where the specific application program is in a second state, which is different from the first state.

### CROSS-REFERENCE TO RELATED APPLICATIONS

This application is based on and claims priority under 35 USC 119 from Japanese Patent Application No. 2018-175038 filed Sep. 19, 2018.

### BACKGROUND

### (i) Technical Field

The present disclosure relates to a display control apparatus, a display apparatus, and a non-transitory computer readable medium.

### (ii) Related Art

For example, Japanese Unexamined Patent Application Publication No. 2013-218695 discloses a method for controlling a flexible display apparatus that provides, when a display section thereof is deformed, a graphic user interface (GUI) guide indicating a deforming gesture related to a function to be executed. This method includes a step for displaying the GUI guide on the display section of the flexible display apparatus. This GUI guide indicates a deforming gesture related to a function to be executed when the deforming gesture is made.

For example, there are display apparatuses including a bendable display section using organic electroluminescence (EL) or the like. Such display apparatuses encompasses the following display apparatus. When a user starts a specific application program on a screen, the user deforms, for example, bends the display section so as to invoke a function related to the application program and to manipulate the display apparatus by using two screens. In this case, the specific application program is often associated with the function that is invoked after the display section has been deformed, in a one-to-one relationship. However, the user may wish to implement various functions in one application program. Thus, it is desired to display an appropriate display content in accordance with the user's purpose or situation of using the application program, depending on deformation of the display section.

### SUMMARY

Aspects of non-limiting embodiments of the present disclosure relate to providing a display control apparatus, a display apparatus, and a non-transitory computer readable medium that is capable of displaying an appropriate display content in accordance with a state of a specific application program if a bendable display is deformed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a display control apparatus including a controller. The controller controls a bendable display to display a first screen if the display is deformed in a state where a specific application program is in a first state. The controller controls the display to display a second screen, which is different from the first screen, if the display is deformed in a state where the specific application program is in a second state, which is different from the first state.

### BRIEF DESCRIPTION OF THE DRAWINGS

Exemplary embodiments of the present disclosure will be described in detail based on the following figures, wherein:

FIG. 1A is a perspective view of a display apparatus according to a first exemplary embodiment in a state where the display apparatus is open;

FIG. 1B a perspective view of the display apparatus according to the first exemplary embodiment in a state where the display apparatus is bent;

FIG. 1C a perspective view of the display apparatus according to the first exemplary embodiment in a state where the display apparatus is closed;

FIG. 2 illustrates an exemplary structure of a display section included in the display apparatus according to the first exemplary embodiment;

FIG. 3 illustrates an exemplary structure of the display section included in the display apparatus according to the first exemplary embodiment in which the display section detects deformation;

FIG. 4 is a block diagram illustrating an exemplary electrical configuration of the display apparatus according to the first exemplary embodiment;

FIG. 5 is a block diagram illustrating an exemplary functional configuration of the display apparatus according to the first exemplary embodiment;

FIG. 6 illustrates an example of a data table according to the first exemplary embodiment;

FIG. 7 is a flowchart illustrating exemplary process flow in a display control program according to the first exemplary embodiment;

FIG. 8 is a flowchart illustrating exemplary flow of screen display processing in accordance with the state of an app in the display control program according to the first exemplary embodiment;

FIG. 9A is a front view of examples of a first state of the app and a first screen according to the first exemplary embodiment;

FIG. 9B is a front view of examples of a second state of the app and a second screen according to the first exemplary embodiment;

FIG. 10 is a front view of another example of the first state of the app according to the first exemplary embodiment;

FIG. 11A is a front view of examples of the first state of the app and the first screen according to a second exemplary embodiment;

FIG. 11B is a front view of examples of the second state of the app and the second screen according to the second exemplary embodiment;

FIG. 12 is a front view of examples of the first state of the app and the first screen according to a third exemplary embodiment;

FIG. 13 is a front view of other examples of the first state of the app and the first screen according to the third exemplary embodiment;

FIG. 14A is a front view of still other examples of the first state of the app and the first screen according to the third exemplary embodiment;

FIG. 14B is a front view of examples of the second state of the app and the second screen according to the third exemplary embodiment;

FIG. 15 is a front view of examples of the first state of the app and the first screen according to a fourth exemplary embodiment;

FIG. 16 is a front view of another example of the first screen of the app according to the fourth exemplary embodiment;

FIG. 17 is a front view of other examples of the first state of the app and the first screen according to the fourth exemplary embodiment;

FIG. 18 is a front view of examples of the first state of the app and the first screen according to a fifth exemplary embodiment;

FIG. 19 is a front view of other examples of the first state of the app and the first screen according to the fifth exemplary embodiment;

FIG. 20A is a front view of examples of the first state of the app and the first screen according to a sixth exemplary embodiment;

FIG. 20B is a front view of examples of the second state of the app and the second screen according to the sixth exemplary embodiment;

FIG. 20C is a front view of examples of a third state of the app and a third screen according to the sixth exemplary embodiment;

FIG. 21 is a front view of examples of a fourth state of the app and a fourth screen according to the sixth exemplary embodiment;

FIG. 22 is a perspective view of an exemplary display apparatus according to a seventh exemplary embodiment in a state where the display apparatus is open; and

FIG. 23 is a perspective view of an exemplary display apparatus according to an eighth exemplary embodiment in a state where the display apparatus is open.

### DETAILED DESCRIPTION

Now, exemplary embodiments of the present disclosure will be described in detail below with reference to the drawings.

### First Exemplary Embodiment

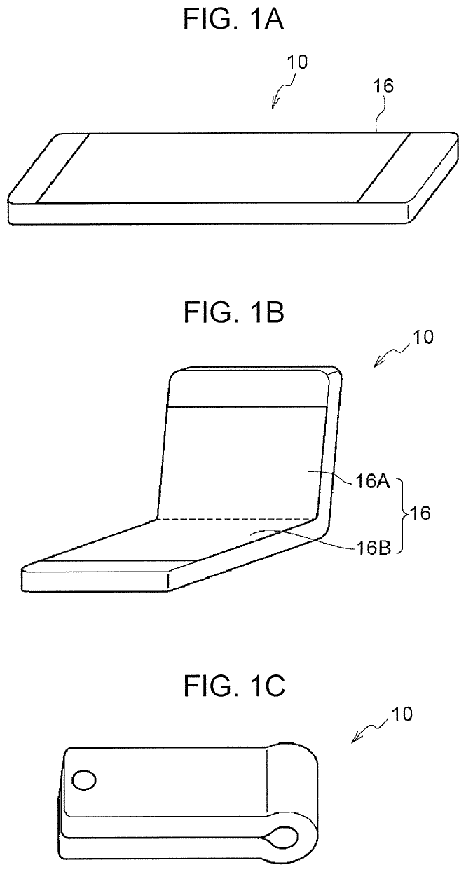

FIG. 1A is a perspective view of a display apparatus 10 according to a first exemplary embodiment in a state where the display apparatus 10 is open. FIG. 1B a perspective view of the display apparatus 10 according to the first exemplary embodiment in a state where the display apparatus 10 is bent. FIG. 1C a perspective view of the display apparatus 10 according to the first exemplary embodiment in a state where the display apparatus 10 is closed.

Various mobile terminal apparatuses are applicable to the display apparatus 10 according to this exemplary embodiment, such as a smartphone, a tablet terminal, a mobile phone device, and a personal digital assistant (PDA). The display apparatus 10 includes a display section 16 that is bendable. Although the display apparatus 10 may have various functions including a telephone call function, this exemplary embodiment focuses on a display function of the display apparatus 10 and will describe applications and effects related to the display function.

As illustrated in FIG. 1A, in a state where the display section 16 is open, the display section 16 has a single display region. On the other hand, as illustrated in FIG. 1B, in a state where the display section 16 is bent, the display section 16 has two display regions. That is, the display section 16 includes a first display region 16A and a second display region 16B. For example, while a screen of a specific application program (hereinafter also simply referred to as “app”) is displayed in the first display region 16A, a screen of functions related to the specific app may be displayed in the second display region 16B. In addition, as an example, after the display apparatus 10, in a state where two screens are displayed on the display section 16 as illustrated in FIG. 1B, has been closed as illustrated in FIG. 1C, the display apparatus 10 may be opened to 180 degrees as illustrated in FIG. 1A in a state where a single screen is displayed again from the state where the two screens are displayed.

Note that the position at which the display section 16 is bent is not limited to the central portion where the area of the first display region 16A and the area of the second display region 16B become substantially equal to each other. For example, the display section 16 may be bent at a position where the area of the first display region 16A becomes larger than the area of the second display region 16B or a position where the area of the first display region 16A becomes smaller than the area of the second display region 16B.

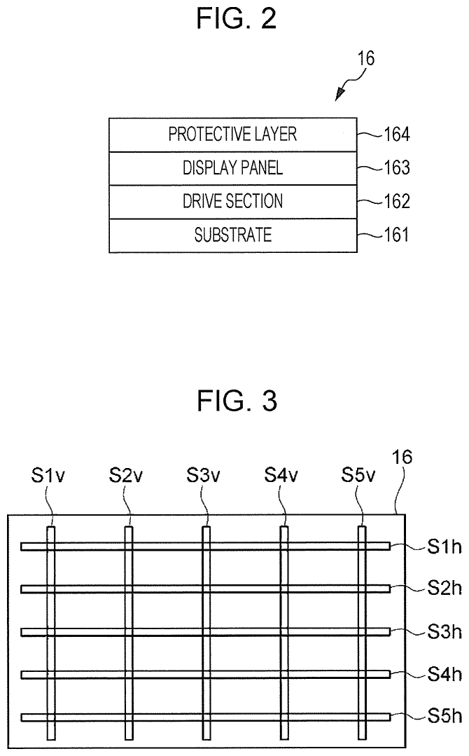

FIG. 2 illustrates an exemplary structure of the display section 16 included in the display apparatus 10 according to this exemplary embodiment.

As illustrated in FIG. 2, the display section 16 according to this exemplary embodiment includes a substrate 161, a drive section 162, a display panel 163, and a protective layer 164. The display section 16 according to this exemplary embodiment is a so-called flexible display.

While having display characteristics of an existing display apparatus, the display section 16 may be deformed to be bent, folded, or wound, for example.

The substrate 161 may be a flexible plastic thin film that is bendable by an external pressure. Exemplary materials of the plastic thin film include various resins such as polyimide, polycarbonate, and polyester. Note that the substrate 161 may alternatively be flexible glass or a metal thin film, for example, instead of the plastic thin film.

The drive section 162 drives the display panel 163. Specifically, the drive section 162 applies a drive voltage to pixels that constitute the display panel 163. For example, the drive section 162 may be formed of thin film transistors (TFTs), low-temperature poly-silicon TFTs (LTPS-TFTs), organic TFTs (OTFTs), and the like. The drive section 162 may be in any form in accordance with the form of the display panel 163. For example, the display panel 163 includes an organic luminescent layer including a plurality of pixel cells and electrode layers that cover both surfaces of the organic luminescent layer. In this case, the drive section 162 includes a plurality of transistors corresponding to the respective electrode cells of the display panel 163.

Instead of the organic light-emitting diode, the display panel 163 may alternatively be formed of, for example, an electroluminescent (EL) display, an electrophoretic display (EPD), an electrochromic display (ECD), a liquid crystal display (LCD), an active matrix LCD (AM-LCD), a plasma display panel (PDP), or the like.

The protective layer 164 protects the display panel 163. The protective layer 164 may be formed of, for example, zirconium oxide (ZrO), cerium oxide (CeO₂), thorium oxide (ThO₂), or the like. The protective layer 164 is formed as a transparent film and is provided to cover the entire surface of the display panel 163.

FIG. 3 illustrates an exemplary structure of the display section 16 included in the display apparatus 10 according to this exemplary embodiment in which the display section 16 detects deformation.

As illustrated in FIG. 3, the display section 16 according to this exemplary embodiment has a lattice structure in which a plurality of bar-like sensors are arranged in both the horizontal direction and the vertical direction.

In the display section 16 illustrated in FIG. 3, a plurality of sensors S1h to S5h (five sensors in this exemplary embodiment) extending in the horizontal direction and a plurality of sensors Sly to S5v (five sensors in this exemplary embodiment) extending in the vertical direction are arranged. As each of the sensors S1h to S5h and Sly to S5v, a sensor whose resistance value changes depending on the degree of deformation is used. That is, the sensor is realized as a strain gauge. The strain gauge detects deformation on a surface of a measurement target depending on a change in the resistance value by using a metal or semiconductor whose resistance changes largely depending on an applied pressure. In general, a material such as a metal has a higher resistance value as the length is increased and has a lower resistance value as the length is decreased, depending on an external pressure. Thus, by detecting a change in the resistance value, it is determined that the display section 16 is deformed. Note that the sensors S1h to S5h and S1v to S5v are electrical-resistance sensors as an example in this exemplary embodiment. Also, the sensors S1h to S5h and S1v to S5v will also be collectively referred to as sensors S1 to S5 in the following description.

The deformation of the display section 16 herein includes typical deformation caused by bending. Note that the bending herein is a state where bent surfaces are not in contact with each other, and the angle between the surfaces is, for example, greater than or equal to 60 degrees and less than or equal to 150 degrees.

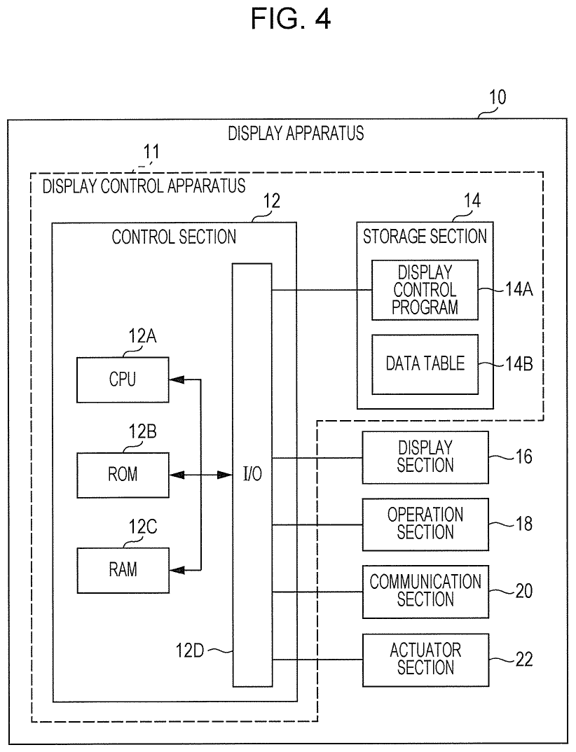

FIG. 4 is a block diagram illustrating an exemplary electrical configuration of the display apparatus 10 according to the first exemplary embodiment.

As illustrated in FIG. 4, the display apparatus 10 according to this exemplary embodiment includes a display control apparatus 11, the display section 16, an operation section 18, a communication section 20, and an actuator section 22. In addition, the display control apparatus 11 includes a control section 12 and a storage section 14.

The control section 12 includes a central processing unit (CPU) 12A, a read only memory (ROM) 12B, a random access memory (RAM) 12C, and an input/output interface (I/O) 12D, which are connected to one another via a bus.

Functional sections including the storage section 14, the display section 16, the operation section 18, the communication section 20, and the actuator section 22 are connected to the I/O 12D. Each of these functional sections is capable of communicating with the CPU 12A through the I/O 12D.

The control section 12 may be configured as a sub-control section that controls part of operation of the display apparatus 10 or part of a main control section that controls the entire operation of the display apparatus 10. Some or all of blocks of the control section 12 are, for example, an integrated circuit such as a large scale integration (LSI) or an integrated circuit (IC) chip. An individual circuit may be used for each of the blocks, or a circuit in which some or all of the blocks are integrated may be used. The blocks may be integrated, or one or more blocks may be separately provided. In addition, part of each of the blocks may be separately provided. The control section 12 may be integrated in the form of, in addition to the LSI, a dedicated circuit or a general processor.

Examples of the storage section 14 include a hard disk drive (HDD), a solid state drive (SSD), and a flash memory. A display control program 14A according to this exemplary embodiment is stored in the storage section 14. Note that the display control program 14A may also be stored in the ROM 12B. In addition, the storage section 14 also stores a data table 14B that is to be used for display control according to this exemplary embodiment.

The display control program 14A may be, for example, installed in the display apparatus 10 in advance. The display control program 14A may be stored in a non-volatile storage medium, or may be distributed via a network, to be installed in the display apparatus 10 as appropriate. Note that examples of the non-volatile storage medium include a compact disc read only memory (CD-ROM), a magneto-optical disk, an HDD, a digital versatile disc read only memory (DVD-ROM), a flash memory, a memory card, and the like.

The above-described organic EL display, for example, is used for the display section 16. Various kinds of information are displayed on the display section 16 in accordance with an app used by a user. The operation section 18 is a touch panel, for example, for operation input. The display section 16 and the operation section 18 are integrated as a single unit and receive various instructions from the user of the display apparatus 10. The display section 16 displays various kinds of information such as a result of processing performed in accordance with an instruction received from the user and a notification for the processing.

The communication section 20 is connected to a network such as the Internet, a local area network (LAN), or a wide area network (WAN), and communication with an external device such as an image forming apparatus or another PC may be performed via the network.

The actuator section 22 controls deformation of the display section 16. Specifically, for example, when the display section 16 is deformed, the actuator section 22 maintains the deformed shape. That is, when a physical force is applied to the display section 16 so as to deform the shape thereof, the display section 16 receives a force in an inverse direction to return to the original, flat shape. In this case, under control of the control section 12, the actuator section 22 applies a physical force corresponding to the force in the inverse direction to maintain the deformed shape of the display section 16.

As described above, it is desired to display an appropriate display content in accordance with the user's purpose or situation of using the app, depending on deformation of the display section 16.

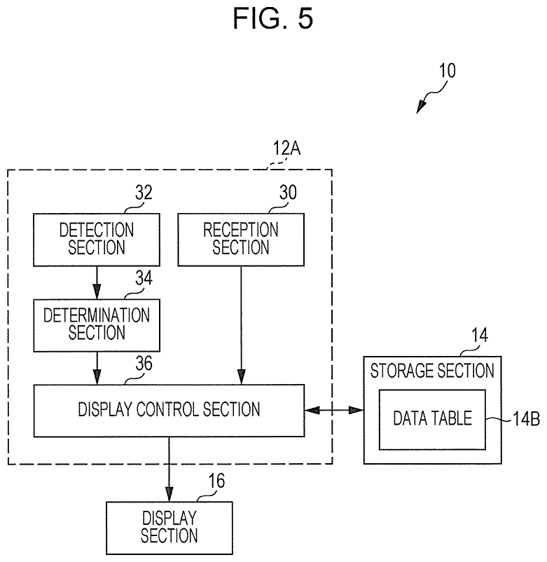

Accordingly, the CPU 12A of the display apparatus 10 according to this exemplary embodiment loads, in the RAM 12C, the display control program 14A stored in the storage section 14 and executes the program, thereby serving as the sections illustrated in FIG. 5.

FIG. 5 is a block diagram illustrating an exemplary functional configuration of the display apparatus 10 according to the first exemplary embodiment.

As illustrated in FIG. 5, the CPU 12A of the display apparatus 10 according to this exemplary embodiment serves as a reception section 30, a detection section 32, a determination section 34, and a display control section 36. Note that the display control section 36 is an example of a controller.

The reception section 30 according to this exemplary embodiment receives an operation input from the user through the operation section 18.

The detection section 32 according to this exemplary embodiment detects deformation of the display section 16. Specifically, the detection section 32 detects the voltage applied to the above-described sensors S1 to S5 (see FIG. 3) or the resistance value on the basis of the current flowing in the sensors S1 to S5 and detects a deformation state at the positions of the sensors S1 to S5 in accordance with the resistance value.

The determination section 34 according to this exemplary embodiment determines the state of the app used by the user. Specifically, the determination section 34 determines whether the app used by the user is in a first state, a second state, or another state. The first state is, for example, a state in which a predetermined basic screen is displayed. The predetermined basic screen is, for example, a home screen of an app, which is displayed after an instruction for executing the app has been given, or a home screen of the display apparatus 10 including the icon of the app. The second state is a state different from the first state and is, for example, a state in which a specific operation screen that is transitioned from the above basic screen is displayed. As screens corresponding to the first and second states, the user may set desired screens for each app, for example.

The display control section 36 according to this exemplary embodiment controls the display section 16 to display a first screen if the app is in the first state and the display section 16 is deformed. Also, the display control section 36 according to this exemplary embodiment controls the display section 16 to display a second screen if the app is in the second state and the display section 16 is deformed. The second screen is a screen different from the first screen. The first screen includes, for example, the above basic screen and another screen related to the basic screen (related screen). The second screen includes, for example, the above specific operation screen and another screen related to the specific operation screen (related screen).

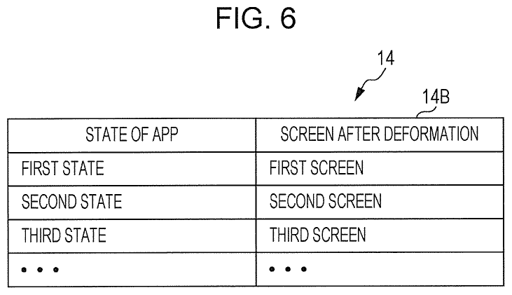

FIG. 6 illustrates an example of the data table 14B according to this exemplary embodiment.

As illustrated in FIG. 6, in the data table 14B according to this exemplary embodiment, screens to be displayed after deformation of the display section 16 are registered in association with states of the app.

That is, if the app is in the first state, the display control section 36 specifies the first screen from the data table 14B illustrated in FIG. 6; and if the app is in the second state, the display control section 36 specifies the second screen from the data table 14B illustrated in FIG. 6.

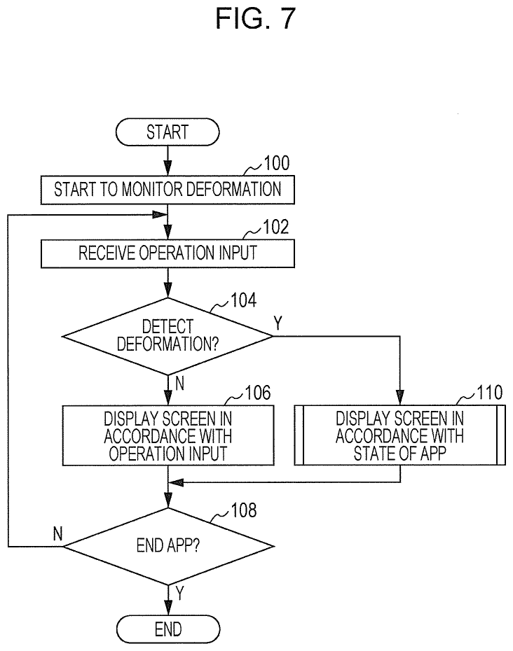

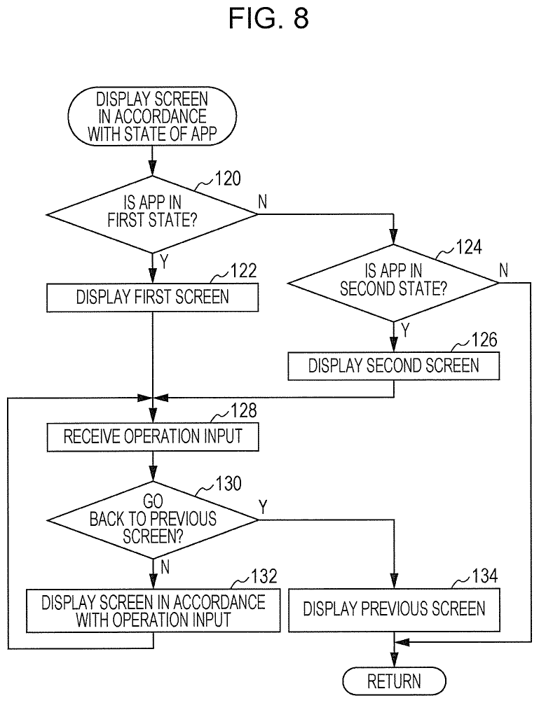

Next, operation of the display apparatus 10 according to the first exemplary embodiment will be described with reference to FIGS. 7 and 8.

FIG. 7 is a flowchart illustrating exemplary process flow in the display control program 14A according to the first exemplary embodiment.

FIG. 8 is a flowchart illustrating exemplary flow of screen display processing in accordance with the state of the app in the display control program 14A according to the first exemplary embodiment.

First, upon starting of the display apparatus 10 and a home screen of the display apparatus 10 being displayed on the display section 16, the display control program 14A is started, and the following steps are performed. Note that the shape of the display apparatus 10 at this stage is, for example, flat as illustrated in FIG. 1A.

In step 100 in FIG. 7, the detection section 32 starts the sensors S1 to S5 (see FIG. 3) provided in the display section 16 to start to monitor deformation of the display section 16.

In step 102, the reception section 30 receives an operation input from the user through the operation section 18. In this exemplary embodiment, as an example, the reception section 30 receives an operation input for starting a specific app from the home screen of the display apparatus 10.

In step 104, it is determined whether the detection section 32 has detected deformation of the display section 16. If it is determined that deformation of the display section 16 is not detected (negative determination), the process proceeds to step 106. If it is determined that deformation of the display section 16 has been detected (positive determination), the process proceeds to step 110. Note that the deformed shape of the display section 16 is, for example, a bent shape as illustrated in FIG. 1B above.

In step 106, the display control section 36 controls the display section 16 to display a screen in accordance with the operation input that has been received in step 102.

In step 108, the display control section 36 determines whether the app that has been started is to end. If it is determined that the app is not to end (negative determination), the process returns to step 102 to repeat the process. If it is determined that the app is to end (positive determination), the entire process according to the display control program 14A ends.

On the other hand, in step 110, the display control section 36 controls the display section 16 to display a screen in accordance with the state of the app, and the process proceeds to step 108. In step 110, as a sub-routine of the display control program 14A, the steps illustrated in FIG. 8 are performed.

In step 120 in FIG. 8, the determination section 34 determines whether the app is in the first state. If it is determined that the app is in the first state (positive determination), the process proceeds to step 122. If it is determined that the app is not in the first state (negative determination), the process proceeds to step 124. In this exemplary embodiment, the first state of the app is, as an example, a state in which the home screen of the app is displayed on the display section 16 as described above.

In step 122, the display control section 36 specifies, as an example, the first screen from the data table 14B illustrated in FIG. 6 above, and controls the display section 16 to display the specified first screen. In this exemplary embodiment, the first screen includes, as an example, the above home screen displayed in the first display region 16A and the related screen of the home screen displayed in the second display region 16B as described above.

In step 124, the determination section 34 determines whether the app is in the second state. If it is determined that the app is in the second state (positive determination), the process proceeds to step 126. If it is determined that the app is not in the second state (negative determination), the process returns to step 108 illustrated in FIG. 7. In this exemplary embodiment, the second state of the app is, as an example, a state in which the specific operation screen transitioned from the above home screen is displayed on the display section 16 as described above.

In step 126, the display control section 36 specifies, as an example, the second screen from the data table 14B illustrated in FIG. 6 above, and controls the display section 16 to display the specified second screen. In this exemplary embodiment, the second screen includes, as an example, the above specific operation screen displayed in the first display region 16A and the related screen of the specific operation screen displayed in the second display region 16B as described above.

In step 128, the reception section 30 receives an operation input from the user through the operation section 18. That is, the reception section 30 receives an operation input on the first screen or the second screen.

In step 130, the detection section 32 determines whether deformation for going back to the previous screen has been detected. If it is determined that deformation for going back to the previous screen has not been detected (negative determination), the process proceeds to step 132. If it is determined that deformation for going back to the previous screen has been detected (positive determination), the process proceeds to step 134.

In step 132, the display control section 36 controls the display section 16 to display a screen in accordance with the operation input that has been received in step 128, and the process returns to step 128 to repeat the process.

In step 134, the display control section 36 controls the display section 16 to display the previous screen, and the process returns to step 108 illustrated in FIG. 7.

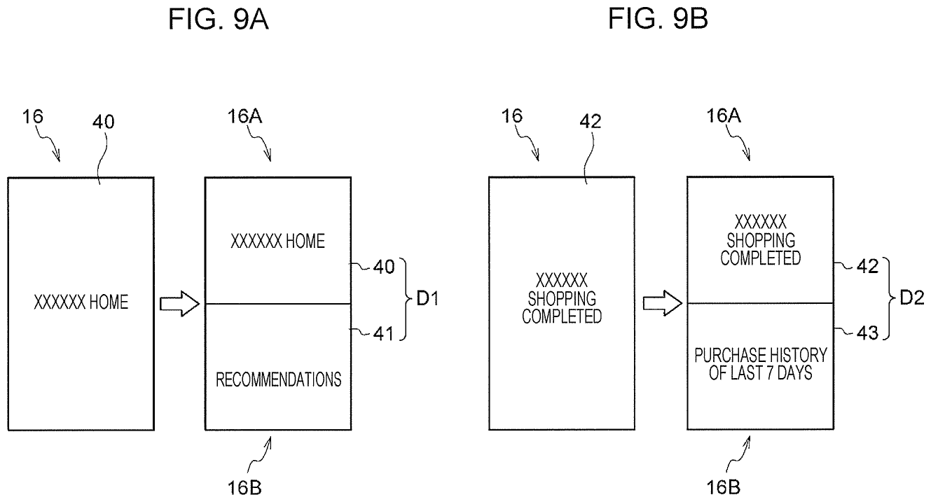

Next, specific examples of the first state of the app and the first screen, and the second state of the app and the second screen according to the first exemplary embodiment will be described with reference to FIGS. 9A and 9B.

FIG. 9A is a front view of examples of the first state of the app and the first screen according to the first exemplary embodiment.

As illustrated in the left part of FIG. 9A, the first state of the app is a state in which a basic screen 40 of the app is displayed on the display section 16. The basic screen 40 is, as an example, a home screen of a shopping app. At this stage, the shape of the display apparatus 10 is flat as illustrated in FIG. 1A above, and upon detection of deformation of the display section 16, a first screen D1 illustrated in the right part of FIG. 9A is displayed. Note that as a result of deformation of the display section 16, the shape of the display apparatus 10 is bent as illustrated in FIG. 1B above.

As illustrated in the right part of FIG. 9A, as the first screen D1, the basic screen 40 is displayed in the first display region 16A, and a related screen 41 of the basic screen 40 is displayed in the second display region 16B. The related screen 41 is, as an example, a screen of “RECOMMENDATIONS” associated with the home screen of the shopping app.

Now, an operation for displaying the original screen again from the screen that is displayed as a result of deformation of the display section 16 will specifically be described with reference to FIGS. 1A to 1C above.

For example, in a state where the display section 16 is bent as illustrated in FIG. 1B, a tap operation as an example is performed on the screen in the first display region 16A, and then, the display section 16 is opened to 180 degrees as illustrated in FIG. 1A. In this case, the screen in the first display region 16A may return to full-screen display.

Alternatively, as described above, the display section 16 that is bent as illustrated in FIG. 1B is closed as illustrated in FIG. 1C, and then, the display section 16 is opened to 180 degrees as illustrated in FIG. 1A. In this case, the screen in the first display region 16A may return to full-screen display.

Further alternatively, the display section 16 that is bent as illustrated in FIG. 1B is closed as illustrated in FIG. 1C, and then, the display section 16 is opened to the angle that is the same as the angle at the time of deformation. In this case, the screen that has been displayed before the display section 16 is closed may be displayed.

Next, operations performed in a case where the display section 16 is in a two-screen state will specifically be described. For example, the following case is assumed. While a user is reading a document, the display section 16 is deformed to display an original text in the first display region 16A and to display a translated text in the second display region 16B.

For example, after the display section 16 has been deformed, any flick operation on the screen in the first display region 16A or the screen in the second display region 16B becomes valid for the two screens. With the flick operation, for example, pages are turned concurrently on the two screens.

Alternatively, after the display section 16 has been deformed, any tap operation on the screen in the first display region 16A or the screen in the second display region 16B becomes valid for the screen that is tapped.

Further alternatively, after the display section 16 has been deformed, any operation (e.g., flick operation or tap operation) on a boundary portion between the screen in the first display region 16A and the screen in the second display region 16B may become valid for the two screens.

FIG. 9B is a front view of examples of the second state of the app and the second screen according to the first exemplary embodiment.

As illustrated in the left part of FIG. 9B, the second state of the app is a state in which an operation screen 42 that is transitioned from the basic screen 40 is displayed on the display section 16. The operation screen 42 is, as an example, a shopping end screen of the shopping app. At this stage, the shape of the display apparatus 10 is flat as illustrated in FIG. 1A above, and upon detection of deformation of the display section 16, a second screen D2 illustrated in the right part of FIG. 9B is displayed. Note that as a result of deformation of the display section 16, the shape of the display apparatus 10 is bent as illustrated in FIG. 1B above.

As illustrated in the right part of FIG. 9B, as the second screen D2, the operation screen 42 is displayed in the first display region 16A, and a related screen 43 of the operation screen 42 is displayed in the second display region 16B. The related screen 43 is, as an example, a screen of “PURCHASE HISTORY OF LAST 7 DAYS” associated with the shopping end screen of the shopping app.

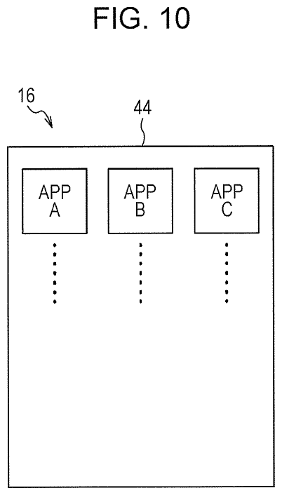

FIG. 10 is a front view of another example of the first state of the app according to the first exemplary embodiment.

As illustrated in FIG. 10, the first state of the app may be a state in which a basic screen 44 of the display apparatus 10 is displayed on the display section 16. The basic screen 44 is, as an example, the home screen of the display apparatus 10 including the icon of the shopping app (icon of “app A” in this exemplary embodiment).

Thus, according to this exemplary embodiment, an appropriate display content in accordance with a specific state of an app, in other words, the user's purpose or situation of using the app, is displayed if the bendable display section is deformed.

### Second Exemplary Embodiment

A second exemplary embodiment will describe a case in which both the first state and the second state of the app are states in which an operation screen corresponding to a user operation is displayed.

In this exemplary embodiment, the first state of the app is a state in which a specific app displays a first operation screen corresponding to a first user operation, whereas the second state of the app is a state in which the specific app displays a second operation screen corresponding to a second user operation.

In addition, the first screen includes the first operation screen and a related screen of the first operation screen, whereas the second screen includes the second operation screen and a related screen of the second operation screen.

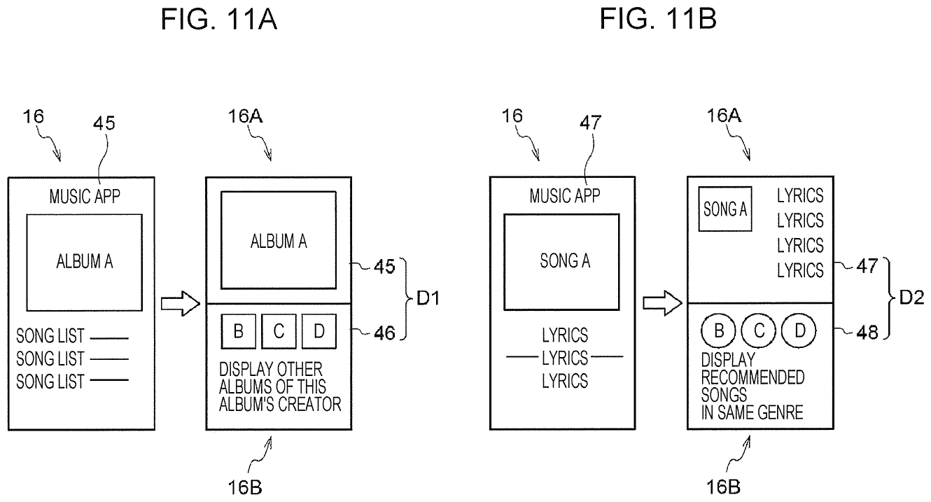

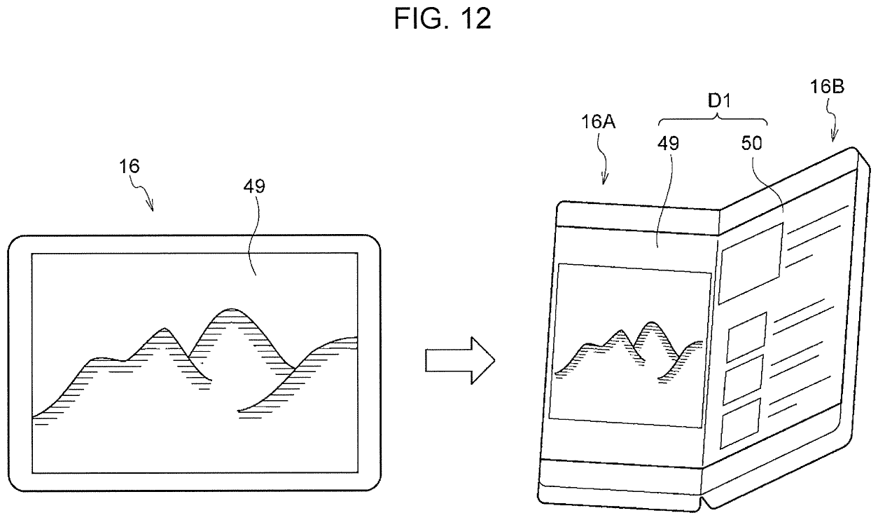

Next, specific examples of the first state of the app and the first screen, and the second state of the app and the second screen according to the second exemplary embodiment will be described with reference to FIGS. 11A and 11B.

FIG. 11A is a front view of examples of the first state of the app and the first screen according to the second exemplary embodiment.

As illustrated in the left part of FIG. 11A, the first state of the app is a state in which a first operation screen 45 of the app is displayed on the display section 16. The first operation screen 45 is, as an example, a song list screen of an album A in a music app. The first operation screen 45 is displayed in response to the first user operation. At this stage, the shape of the display apparatus 10 is flat as illustrated in FIG. 1A above, and upon detection of deformation of the display section 16, the first screen D1 illustrated in the right part of FIG. 11A is displayed. Note that as a result of deformation of the display section 16, the shape of the display apparatus 10 is bent as illustrated in FIG. 1B above.

As illustrated in the right part of FIG. 11A, as the first screen D1, the first operation screen 45 is displayed in the first display region 16A, and a related screen 46 of the first operation screen 45 is displayed in the second display region 16B. The related screen 46 is, as an example, a screen of “OTHER ALBUMS OF THIS ALBUM'S CREATOR” associated with the song list screen of the album A in the music app.

FIG. 11B is a front view of examples of the second state of the app and the second screen according to the second exemplary embodiment.

As illustrated in the left part of FIG. 11B, the second state of the app is a state in which a second operation screen 47 of the app is displayed on the display section 16. The second operation screen 47 is, as an example, a lyrics screen of a song A in the music app. The second operation screen 47 is displayed in response to the second user operation. At this stage, the shape of the display apparatus 10 is flat as illustrated in FIG. 1A above, and upon detection of deformation of the display section 16, the second screen D2 illustrated in the right part of FIG. 11B is displayed. Note that as a result of deformation of the display section 16, the shape of the display apparatus 10 is bent as illustrated in FIG. 1B above.

As illustrated in the right part of FIG. 11B, as the second screen D2, the second operation screen 47 is displayed in the first display region 16A, and a related screen 48 of the second operation screen 47 is displayed in the second display region 16B. The related screen 48 is, as an example, a screen of “RECOMMENDED SONGS IN SAME GENRE” associated with the lyrics screen of the song A in the music app.

### Third Exemplary Embodiment

A third exemplary embodiment will describe a case in which, as a related screen of an operation screen of an app, a screen related to the functions of the app is displayed.

In this exemplary embodiment, a related screen of each of the first operation screen and the second operation screen of the app is a screen related to the functions of the app.

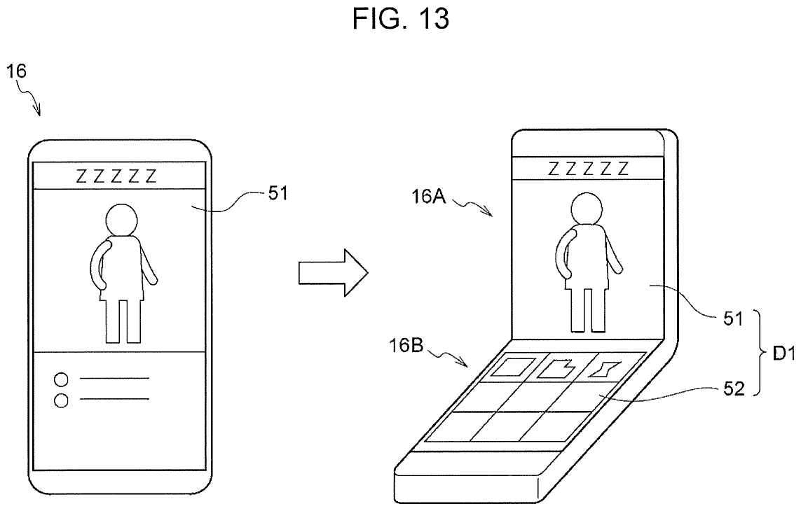

Next, specific examples of the first state of the app and the first screen according to the third exemplary embodiment will be described with reference to FIGS. 12 and 13. Note that description of the second state of the app and the second screen will be omitted in the examples illustrated in FIGS. 12 and 13.

FIG. 12 is a front view of examples of the first state of the app and the first screen according to the third exemplary embodiment.

As illustrated in the left part of FIG. 12, the first state of the app is a state in which a first operation screen 49 of the app is displayed on the display section 16. The first operation screen 49 is, as an example, a video-playing screen in a video app. The first operation screen 49 is displayed in response to the first user operation. At this stage, the shape of the display apparatus 10 is flat as illustrated in FIG. 1A above, and upon detection of deformation of the display section 16, the first screen D1 illustrated in the right part of FIG. 12 is displayed. Note that as a result of deformation of the display section 16, the shape of the display apparatus 10 is bent as illustrated in FIG. 1B above.

As illustrated in the right part of FIG. 12, as the first screen D1, the first operation screen 49 is displayed in the first display region 16A, and a related screen 50 of the first operation screen 49 is displayed in the second display region 16B. The related screen 50 is, as an example, a screen of “video playback history” associated with the video-playing screen in the video app.

FIG. 13 is a front view of other examples of the first state of the app and the first screen according to the third exemplary embodiment.

As illustrated in the left part of FIG. 13, the first state of the app is a state in which a first operation screen 51 of the app is displayed on the display section 16. The first operation screen 51 is, as an example, a product-searching screen in a fashion online shopping app. The first operation screen 51 is displayed in response to the first user operation. At this stage, the shape of the display apparatus 10 is flat as illustrated in FIG. 1A above, and upon detection of deformation of the display section 16, the first screen D1 illustrated in the right part of FIG. 13 is displayed. Note that as a result of deformation of the display section 16, the shape of the display apparatus 10 is bent as illustrated in FIG. 1B above.

As illustrated in the right part of FIG. 13, as the first screen D1, the first operation screen 51 is displayed in the first display region 16A, and a related screen 52 of the first operation screen 51 is displayed in the second display region 16B. The related screen 52 is, as an example, a screen of “search history” associated with the product-searching screen in the fashion online shopping app.

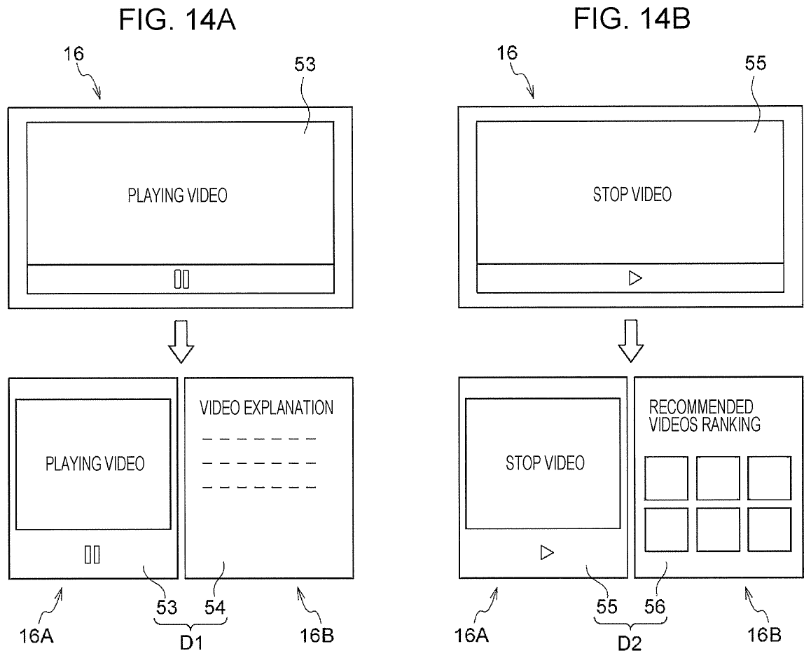

Next, specific examples of the first state of the app and the first screen, and the second state of the app and the second screen according to the third exemplary embodiment will be described with reference to FIGS. 14A and 14B.

FIG. 14A is a front view of still other examples of the first state of the app and the first screen according to the third exemplary embodiment.

As illustrated in the upper part of FIG. 14A, the first state of the app is a state in which a first operation screen 53 of the app is displayed on the display section 16. The first operation screen 53 is, as an example, a video-playing screen in a video app. The first operation screen 53 is displayed in response to the first user operation. At this stage, the shape of the display apparatus 10 is flat as illustrated in FIG. 1A above, and upon detection of deformation of the display section 16, the first screen D1 illustrated in the lower part of FIG. 14A is displayed. Note that as a result of deformation of the display section 16, the shape of the display apparatus 10 is bent as illustrated in FIG. 1B above.

As illustrated in the lower part of FIG. 14A, as the first screen D1, the first operation screen 53 is displayed in the first display region 16A, and a related screen 54 of the first operation screen 53 is displayed in the second display region 16B. The related screen 54 is, as an example, a screen of “VIDEO EXPLANATION” associated with the video-playing screen in the video app.

FIG. 14B is a front view of examples of the second state of the app and the second screen according to the third exemplary embodiment.

As illustrated in the upper part of FIG. 14B, the second state of the app is a state in which a second operation screen 55 of the app is displayed on the display section 16. The second operation screen 55 is, as an example, a video-stopped screen in the video app. The second operation screen 55 is displayed in response to the second user operation. At this stage, the shape of the display apparatus 10 is flat as illustrated in FIG. 1A above, and upon detection of deformation of the display section 16, the second screen D2 illustrated in the lower part of FIG. 14B is displayed. Note that as a result of deformation of the display section 16, the shape of the display apparatus 10 is bent as illustrated in FIG. 1B above.

As illustrated in the lower part of FIG. 14B, as the second screen D2, the second operation screen 55 is displayed in the first display region 16A, and a related screen 56 of the second operation screen 55 is displayed in the second display region 16B. The related screen 56 is, as an example, a screen of “RECOMMENDED VIDEOS RANKING” associated with the video-stopped screen in the video app.

### Fourth Exemplary Embodiment

A fourth exemplary embodiment will describe a case in which, as a related screen of an app operation screen, a screen of an app that is different from the above app is displayed.

In this exemplary embodiment, a related screen of each of the first operation screen and the second operation screen of an app is a screen of an app that is different from the above app.

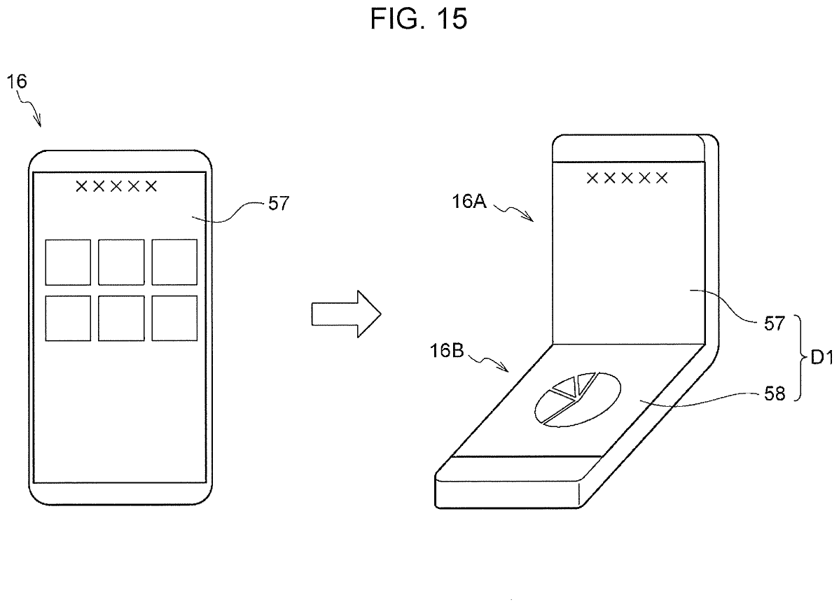

Next, specific examples of the first state of the app and the first screen according to the fourth exemplary embodiment will be described with reference to FIGS. 15, 16, and 17. Note that description of the second state of the app and the second screen will be omitted in the examples illustrated in FIGS. 15, 16, and 17.

FIG. 15 is a front view of examples of the first state of the app and the first screen according to the fourth exemplary embodiment.

As illustrated in the left part of FIG. 15, the first state of the app is a state in which a first operation screen 57 of the app is displayed on the display section 16. The first operation screen 57 is, as an example, a payment process screen in a shopping app. The first operation screen 57 is displayed in response to the first user operation. At this stage, the shape of the display apparatus 10 is flat as illustrated in FIG. 1A above, and upon detection of deformation of the display section 16, the first screen D1 illustrated in the right part of FIG. 15 is displayed. Note that as a result of deformation of the display section 16, the shape of the display apparatus 10 is bent as illustrated in FIG. 1B above.

As illustrated in the right part of FIG. 15, as the first screen D1, the first operation screen 57 is displayed in the first display region 16A, and a related screen 58 of the first operation screen 57 is displayed in the second display region 16B. The related screen 58 is, as an example, a screen of a household account app, which is different from the shopping app. That is, in this exemplary embodiment, if a payment process in the shopping app is followed by a bending operation, the household account app related to the payment process screen is set to be started.

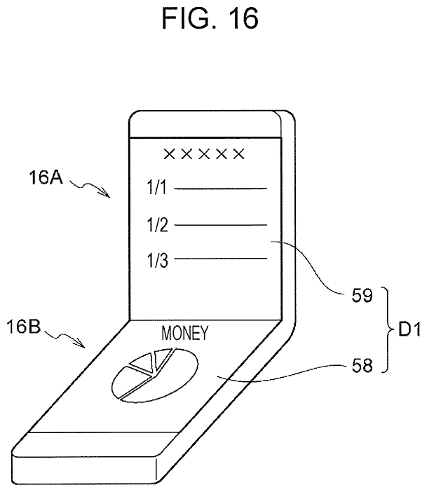

FIG. 16 is a front view of another example of the first screen of the app according to the fourth exemplary embodiment.

As illustrated in FIG. 16, as the first screen D1, a related screen 59 of the first operation screen 57 is displayed in the first display region 16A, and the related screen 58 is displayed in the second display region 16B. The related screen 59 is, as an example, a screen of “purchase history” of the shopping app. In the above manner, as the first screen D1, the related screen 59 being a screen related to functions of the app and the related screen 58 being a screen of an app that is different from the above app may be displayed.

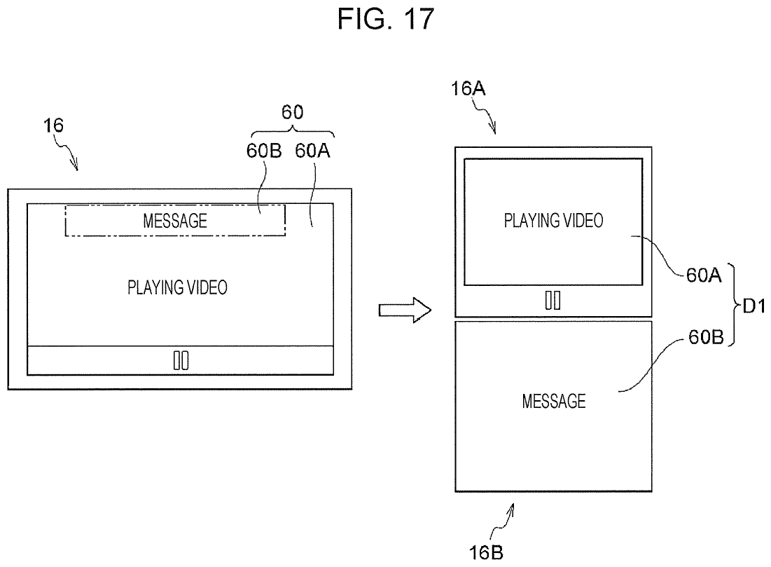

FIG. 17 is a front view of other examples of the first state of the app and the first screen according to the fourth exemplary embodiment.

As illustrated in the left part of FIG. 17, the first state of the app is a state in which a first operation screen 60 of the app is displayed on the display section 16. The first operation screen 60 is, as an example, a screen including a first screen region 60A and a second screen region 60B. The first screen region 60A corresponds to a video app, and the second screen region 60B corresponds to a message app, which is different from the video app. A video that is being played is displayed in the first screen region 60A, and a received message is displayed in the second screen region 60B. At this stage, the shape of the display apparatus 10 is flat as illustrated in FIG. 1A above, and upon detection of deformation of the display section 16, the first screen D1 illustrated in the right part of FIG. 17 is displayed. Note that as a result of deformation of the display section 16, the shape of the display apparatus 10 is bent as illustrated in FIG. 1B above.

As illustrated in the right part of FIG. 17, as the first screen D1, information of the first screen region 60A on the first operation screen 60 is displayed in the first display region 16A, and information of the second screen region 60B as a related screen of the first operation screen 60 is displayed in the second display region 16B. In the example illustrated in FIG. 17, the information of the first screen region 60A is a video that is being played, and the information of the second screen region 60B is a character string.

### Fifth Exemplary Embodiment

A fifth exemplary embodiment will describe a case in which, if deformation is detected, the same screen as the original screen is not displayed as the first screen, but a changed screen in which the operation status of the original screen is changed is displayed as the first screen.

In this exemplary embodiment, the first state of an app is a state in which the app displays the first operation screen in response to the first user operation, and the first screen includes a changed screen and a related screen of the changed screen, the changed screen being obtained by changing the operation status of the first operation screen.

In addition, the second state of the app is a state in which the app displays the second operation screen in response to the second user operation, and the second screen includes a changed screen and a related screen of the changed screen, the changed screen being obtained by changing the operation status of the second operation screen.

Furthermore, the first operation screen includes a first screen region and a second screen region. The first screen region corresponds to a specific app, and the second screen region corresponds to an app that is different from the specific app. The changed screen displays only information of the first screen region, whereas the related screen of the changed screen displays only information of the second screen region.

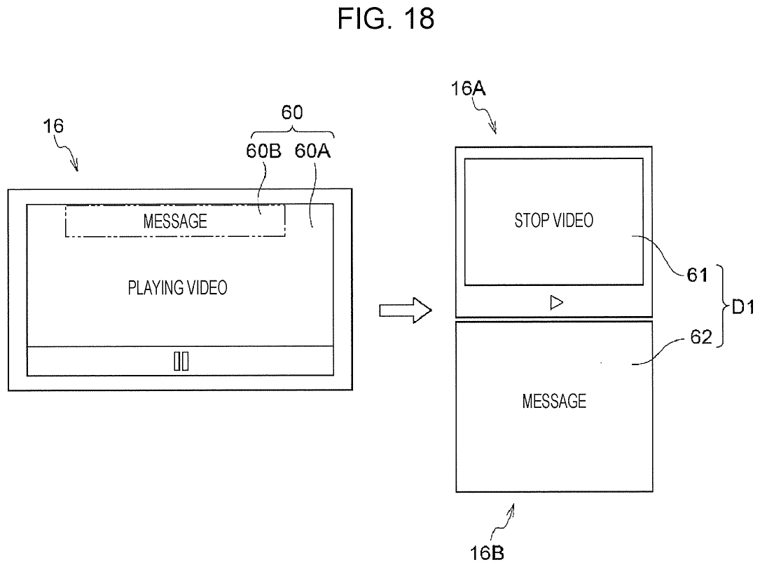

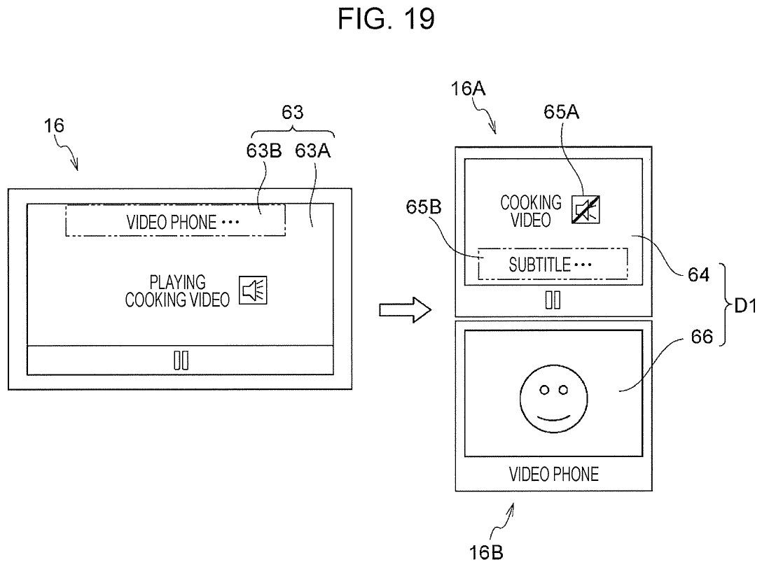

Next, specific examples of the first state of the app and the first screen according to the fifth exemplary embodiment will be described with reference to FIGS. 18 and 19. Note that description of the second state of the app and the second screen will be omitted in the examples illustrated in FIGS. 18 and 19.

FIG. 18 is a front view of examples of the first state of the app and the first screen according to the fifth exemplary embodiment.

As illustrated in the left part of FIG. 18, the first state of the app is a state in which the first operation screen 60 of the app is displayed on the display section 16. The first operation screen 60 is a screen including the first screen region 60A corresponding to a video app and the second screen region 60B corresponding to a message app as in the example illustrated in FIG. 17. At this stage, the shape of the display apparatus 10 is flat as illustrated in FIG. 1A above, and upon detection of deformation of the display section 16, the first screen D1 illustrated in the right part of FIG. 18 is displayed. Note that as a result of deformation of the display section 16, the shape of the display apparatus 10 is bent as illustrated in FIG. 1B above.

As illustrated in the right part of FIG. 18, as the first screen D1, a changed screen 61 is displayed in the first display region 16A, and a related screen 62 of the changed screen 61 is displayed in the second display region 16B. The changed screen 61 is a screen obtained by changing the operation status of the first operation screen 60. In the example illustrated in FIG. 18, the operation status is changed from “playing” to “stopped”. In addition, the changed screen 61 displays only information of the first screen region 60A, whereas the related screen 62 displays only information of the second screen region 60B. In the example illustrated in FIG. 18, the information of the first screen region 60A is a stopped video, whereas the information of the second screen region 60B is a character string.

FIG. 19 is a front view of other examples of the first state of the app and the first screen according to the fifth exemplary embodiment.

As illustrated in the left part of FIG. 19, the first state of the app is a state in which a first operation screen 63 of the app is displayed on the display section 16. The first operation screen 63 is, as an example, a screen including a first screen region 63A and a second screen region 63B. The first screen region 63A corresponds to a video app, whereas the second screen region 63B corresponds to a video-phone app, which is different from the video app. A cooking video that is being played is displayed with sound in the first screen region 63A, whereas an image of a partner who has made a video-phone call is displayed in the second screen region 63B. At this stage, the shape of the display apparatus 10 is flat as illustrated in FIG. 1A above, and upon detection of deformation of the display section 16, the first screen D1 illustrated in the right part of FIG. 19 is displayed. Note that as a result of deformation of the display section 16, the shape of the display apparatus 10 is bent as illustrated in FIG. 1B above.

As illustrated in the right part of FIG. 19, as the first screen D1, a changed screen 64 is displayed in the first display region 16A, and a related screen 66 of the changed screen 64 is displayed in the second display region 16B. The changed screen 64 is a screen obtained by changing the operation status of the first operation screen 63. In the example illustrated in FIG. 19, the changed screen 64 displays a cooking video that is being played and a subtitle 65B of a video sound 65A that has been muted. In addition, the changed screen 64 displays only information of the first screen region 63A, whereas the related screen 66 displays only information of the second screen region 63B. In the example illustrated in FIG. 19, the information of the first screen region 63A is a video that is being played, whereas the information of the second screen region 63B is an image with sound.

### Sixth Exemplary Embodiment

A sixth exemplary embodiment will describe a case in which, if an app is in a third state and deformation is detected, a third screen is displayed.

If the app is in the first state and the display section 16 is deformed, the display control section 36 according to this exemplary embodiment controls the display section 16 to display the first screen; if the app is in the second state and the display section 16 is deformed, the display control section 36 according to this exemplary embodiment controls the display section 16 to display the second screen; and if the app is in the third state and the display section 16 is deformed, the display control section 36 according to this exemplary embodiment controls the display section 16 to display the third screen.

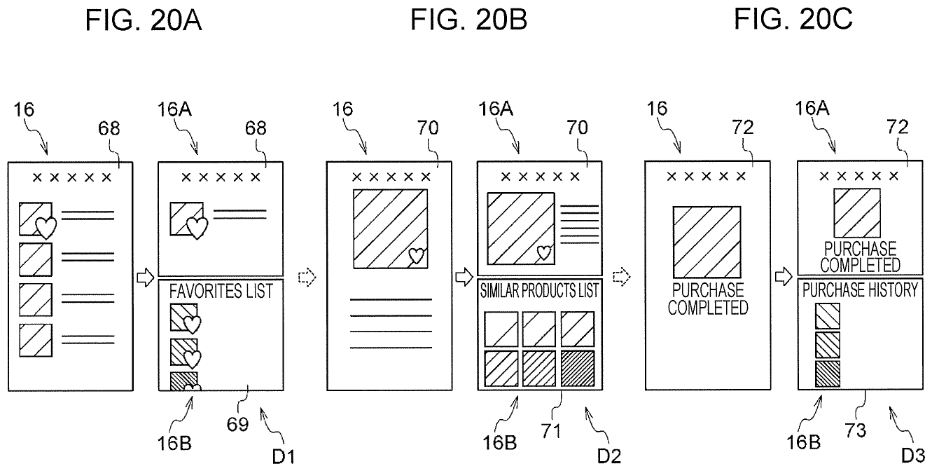

Next, specific examples of the first state of the app and the first screen, the second state of the app and the second screen, and the third state of the app and the third screen according to the sixth exemplary embodiment will be described with reference to FIGS. 20A, 20B, and 20C.

FIG. 20A is a front view of examples of the first state of the app and the first screen according to the sixth exemplary embodiment.

As illustrated in the left part of FIG. 20A, the first state of the app is a state in which a first operation screen 68 of the app is displayed on the display section 16. The first operation screen 68 is, as an example, a product list screen in a shopping app. At this stage, the shape of the display apparatus 10 is flat as illustrated in FIG. 1A above, and upon detection of deformation of the display section 16, the first screen D1 illustrated in the right part of FIG. 20A is displayed. Note that as a result of deformation of the display section 16, the shape of the display apparatus 10 is bent as illustrated in FIG. 1B above.

As illustrated in the right part of FIG. 20A, as the first screen D1, the first operation screen 68 is displayed in the first display region 16A, and a related screen 69 of the first operation screen 68 is displayed in the second display region 16B. The related screen 69 is, as an example, a screen of “FAVORITES LIST” associated with the product list screen in the shopping app. Note that if a selection operation such as a double-tap operation is performed, as an example, on the screen of “FAVORITES LIST”, the screen of “FAVORITES LIST” may be switched to full-screen display (one-screen display) without restoring the display apparatus 10 to a flat state from the deformed state. In addition, if a selection operation of a simple tap is performed on the screen of “FAVORITES LIST”, the operation may be received as an operation on the screen of “FAVORITES LIST” with the two-screen state maintained.

FIG. 20B is a front view of examples of the second state of the app and the second screen according to the sixth exemplary embodiment.

As illustrated in the left part of FIG. 20B, the second state of the app is a state in which a second operation screen 70 transitioned from the first operation screen 68 is displayed on the display section 16. The second operation screen 70 is, as an example, a product details screen in the shopping app. At this stage, the shape of the display apparatus 10 is flat as illustrated in FIG. 1A above, and upon detection of deformation of the display section 16, the second screen D2 illustrated in the right part of FIG. 20B is displayed. Note that as a result of deformation of the display section 16, the shape of the display apparatus 10 is bent as illustrated in FIG. 1B above.

As illustrated in the right part of FIG. 20B, as the second screen D2, the second operation screen 70 is displayed in the first display region 16A, and a related screen 71 of the second operation screen 70 is displayed in the second display region 16B. The related screen 71 is, as an example, a screen of “SIMILAR PRODUCTS LIST” associated with the product details screen in the shopping app.

FIG. 20C is a front view of examples of the third state of the app and the third screen according to the sixth exemplary embodiment.

As illustrated in the left part of FIG. 20C, the third state of the app is a state in which a third operation screen 72 transitioned from the second operation screen 70 is displayed on the display section 16. The third operation screen 72 is, as an example, a purchase completion screen in the shopping app. At this stage, the shape of the display apparatus 10 is flat as illustrated in FIG. 1A above, and upon detection of deformation of the display section 16, a third screen D3 illustrated in the right part of FIG. 20C is displayed. Note that as a result of deformation of the display section 16, the shape of the display apparatus 10 is bent as illustrated in FIG. 1B above.

As illustrated in the right part of FIG. 20C, as the third screen D3, the third operation screen 72 is displayed in the first display region 16A, and a related screen 73 of the third operation screen 72 is displayed in the second display region 16B. The related screen 73 is, as an example, a screen of “PURCHASE HISTORY” associated with the purchase completion screen in the shopping app.

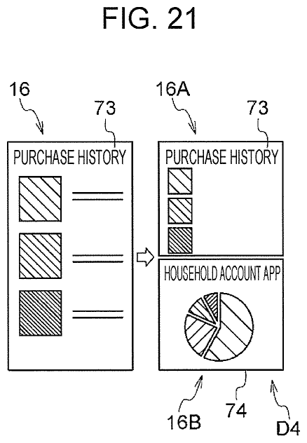

FIG. 21 is a front view of examples of a fourth state of the app and a fourth screen according to the sixth exemplary embodiment.

As illustrated in the left part of FIG. 21, the fourth state of the app is a state in which a fourth operation screen 73 transitioned from the third operation screen 72 is displayed on the display section 16. The fourth operation screen 73 is, as an example, a screen of “PURCHASE HISTORY” in the shopping app and is the same as the related screen 73 in this example. At this stage, the shape of the display apparatus 10 is flat as illustrated in FIG. 1A above, and upon detection of deformation of the display section 16, a fourth screen D4 illustrated in the right part of FIG. 21 is displayed. Note that as a result of deformation of the display section 16, the shape of the display apparatus 10 is bent as illustrated in FIG. 1B above.

As illustrated in the right part of FIG. 21, as the fourth screen D4, the fourth operation screen 73 is displayed in the first display region 16A, and a related screen 74 of the fourth operation screen 73 is displayed in the second display region 16B. The related screen 74 is, as an example, a screen of a different app that is “HOUSEHOLD ACCOUNT APP” associated with the screen of “PURCHASE HISTORY” in the shopping app. Note that upon completion of purchase of a product, “HOUSEHOLD ACCOUNT APP” may automatically be displayed in the second display region 16B.

### Seventh Exemplary Embodiment

A seventh exemplary embodiment will describe a case in which a screen after deformation has a two-screen configuration including a main screen and a sub-screen.

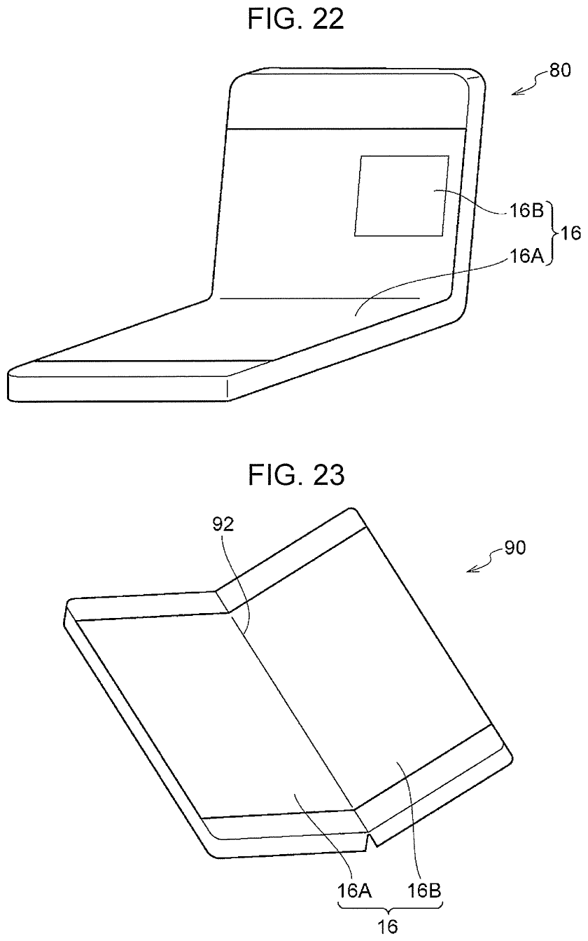

FIG. 22 is a perspective view of an exemplary display apparatus 80 according to the seventh exemplary embodiment in a state where the display apparatus 80 is open.

As illustrated in FIG. 22, the display section 16 of the display apparatus 80 according to this exemplary embodiment has a two-screen configuration including the main screen and the sub-screen. The main screen is displayed in the first display region 16A, and the sub-screen is displayed in the second display region 16B.

Unlike in the two-screen configuration of the display apparatus 10 according to the first exemplary embodiment, the display apparatus 80 illustrated in FIG. 22 includes the main screen and the sub-screen having different screen sizes. That is, in the display apparatus 80 according to this exemplary embodiment, the two-screen configuration is made by superposing the sub-screen on the main screen, not as the two-screen configuration in which each screen is independent.

### Eighth Exemplary Embodiment

An eighth exemplary embodiment will describe a case in which a display apparatus has a two-screen configuration using a hinge mechanism.

FIG. 23 is a perspective view of an exemplary display apparatus 90 according to the eighth exemplary embodiment in a state where the display apparatus 90 is open.

As illustrated in FIG. 23, in the display section 16 of the display apparatus 90 according to this exemplary embodiment, a screen in the first display region 16A and a screen in the second display region 16B are coupled to each other with a hinge mechanism 92.

Unlike in the two-screen configuration of the display apparatus 10 according to the first exemplary embodiment, the display apparatus 90 illustrated in FIG. 23 has the two-screen configuration using the hinge mechanism 92. That is, although the display section 16 is flexibly deformed in the display apparatus 10 according to the first exemplary embodiment, the display section 16 is deformed by using the hinge mechanism 92 in the display apparatus 90 according to this exemplary embodiment.

The exemplary display apparatuses including the display control apparatuses according to the exemplary embodiments have been described above. In some exemplary embodiments, it is also possible to provide a program for causing a computer to execute the functions of the sections included in the display apparatuses. In some exemplary embodiments, it is also possible to provide a computer readable medium storing the program.

The configurations of the display apparatuses described in the above exemplary embodiments are examples and may be modified in accordance with a situation without departing from the spirit of the present disclosure.

In addition, the process flows of programs described in the above exemplary embodiments are also examples, and unnecessary steps may be skipped, new steps may be added, or the processing order may be changed, without departing from the spirit of the present disclosure.

Furthermore, the above exemplary embodiments have described cases in which the programs are executed to perform the processes according to the exemplary embodiments by a software configuration by using a computer. However, the present disclosure is not limited to these exemplary embodiments, and the exemplary embodiments may be implemented by, for example, a hardware configuration or combination of a hardware configuration and a software configuration.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A display control apparatus comprising:
a controller that controls a bendable display to display a first screen if the display is deformed in a state where a specific application program is in a first state and controls the display to display a second screen, which is different from the first screen, if the display is deformed in a state where the specific application program is in a second state, which is different from the first state.

2. The display control apparatus according to claim 1,
wherein the first state is a state where a predetermined basic screen is displayed, and
wherein the second state is a state where a specific operation screen that is transitioned from the basic screen is displayed.

3. The display control apparatus according to claim 2, wherein the basic screen is a home screen of the specific application program, the home screen being displayed in response to an instruction for executing the specific application program.

4. The display control apparatus according to claim 2, wherein the basic screen is a home screen of the display control apparatus including an icon of the specific application program.

5. The display control apparatus according to claim 2,
wherein the first screen includes the basic screen and another screen that is related to the basic screen, and
wherein the second screen includes the specific operation screen and another screen that is related to the specific operation screen.

6. The display control apparatus according to claim 1,
wherein the first state is a state where the specific application program displays a first operation screen in response to a first user operation, and
wherein the second state is a state where the specific application program displays a second operation screen in response to a second user operation.

7. The display control apparatus according to claim 6,
wherein the first screen includes the first operation screen and another screen that is related to the first operation screen, and
wherein the second screen includes the second operation screen and another screen that is related to the second operation screen.

8. The display control apparatus according to claim 7, wherein the other screen that is related to the first operation screen and the other screen that is related to the second operation screen are any of a screen related to a function of the specific application program and a screen of an application program that is different from the specific application program.

9. The display control apparatus according to claim 1,
wherein the first state is a state where the specific application program displays a first operation screen in response to a first user operation, and
wherein the first screen includes a changed screen and another screen that is related to the changed screen, the changed screen being obtained by changing an operation status of the first operation screen.

10. The display control apparatus according to claim 9,
wherein the second state is a state where the specific application program displays a second operation screen in response to a second user operation, and
wherein the second screen includes a changed screen and another screen that is related to the changed screen, the changed screen being obtained by changing an operation status of the second operation screen.

11. The display control apparatus according to claim 9,
wherein the first operation screen includes a first screen region and a second screen region, the first screen region corresponding to the specific application program, the second screen region corresponding to an application program that is different from the specific application program,
wherein the changed screen displays information of the first screen region, and
wherein the other screen that is related to the changed screen displays information of the second screen region.

12. The display control apparatus according to claim 11,
wherein the information of the first screen region is a video, and
wherein the information of the second screen region is a character string.

13. The display control apparatus according to claim 11,
wherein the information of the first screen region is a video, and
wherein the information of the second screen region is an image with sound.

14. The display control apparatus according to claim 13,
wherein the changed screen displays the video and muted sound of the video in the form of a subtitle, and
wherein the other screen that is related to the changed screen displays the image with sound.

15. A display apparatus comprising:
the display control apparatus according to claim 1; and
a bendable display that displays a display content that is controlled by the display control apparatus.

16. A non-transitory computer readable medium storing a program causing a computer to execute a process for display control, the process comprising:
controlling a bendable display to display a first screen if the display is deformed in a state where a specific application program is in a first state; and
controlling the display to display a second screen, which is different from the first screen, if the display is deformed in a state where the specific application program is in a second state, which is different from the first state.
